(19) United States
(12) Patent Application Publication
(10) Pub. No.: US 2025/0115061 A1
(43) Pub. Date: Apr. 10, 2025

(54) CARD ISSUING DEVICE

(71) Applicant: NIDEC INSTRUMENTS CORPORATION, Nagano (JP)

(72) Inventor: Satoshi YOKOYAMA, Nagano (JP)

(21) Appl. No.: 18/905,149

(22) Filed: Oct. 3, 2024

(30) Foreign Application Priority Data
Oct. 4, 2023 (JP) 2023-172613

(51) Int. Cl. B41J 11/057; B41J 2/325; B41J 3/407; B41J 35/04

(52) U.S. Cl. CPC B41J 11/057; B41J 2/325; B41J 3/407; B41J 35/04

(57) ABSTRACT

A card issuing device includes: a thermal head that prints onto a card by heating; a circular platen roller that is disposed opposite to the thermal head and conveys the card by rotating while holding the card between the thermal head and the platen roller; and an ink ribbon conveyed while being superposed on the card between the thermal head and the platen roller. In the platen roller, the outer diameter of the two end portions is larger than the outer diameter at the central portion.

### CROSS REFERENCE TO RELATED APPLICATION

The present invention claims priority under 35 U.S.C. § 119 to Japanese Application No. 2023-172613 filed Oct. 4, 2023, the entire content of which is incorporated herein by reference.

### BACKGROUND

### Field of the Invention

At least an embodiment of the present invention relates to a card issuing device including a thermal head for printing onto a medium.

### Description of the Related Documents

A card issuing device with a thermal head for printing onto a card is described in Japanese Unexamined Patent Application Publication No. 2020-179616. The card issuing device disclosed in Japanese Unexamined Patent Application Publication No. 2020-179616 includes a thermal head for printing onto a card, platen rollers that are positioned directly below the thermal head and convey the card, and an ink ribbon that is conveyed between the thermal head and the platen rollers while being superposed on the card. The thermal head is pressed against the card from above the ink ribbon to print onto the card. The thermal head can print onto the entire surface of the card. All of the platen rollers have a circular shape with the same diameter. The platen rollers support the card from below when the thermal head prints onto the card.

In the card issuing device disclosed in Japanese Unexamined Patent Publication No. 2020-179616, during printing onto a card, the pressing force of a thermal head against the card via an ink ribbon tends to concentrate on the central portion of the card. Therefore, there is a problem in that the printing is rubbed because the pressing force of the thermal head against the card via the ink ribbon is weak at the outer peripheral edge of the card in the width direction orthogonal to the conveyance direction of the card.

An object of at least an embodiment of the present invention, which has been conceived in view of the above problem, is to provide a card issuing device capable of suppressing rubbing of printing on the outer peripheral edge of a card in the width direction of the card when a thermal head prints onto the card.

### SUMMARY

To solve the above problem, a card issuing device includes: a thermal head that prints onto a medium by heating; a circular platen roller that is disposed opposite to the thermal head and conveys the medium by rotating while the medium is held between the platen roller and the thermal head; and an ink ribbon that is conveyed between the thermal head and the platen roller while the ink ribbon is superposed with the medium, wherein an outer diameter at two end portions of the platen roller is larger than an outer diameter at a central portion of the platen roller.

According to at least an embodiment of the present invention, the outer diameter of the platen roller at the two end portions is larger than the outer diameter at the central portion of the platen roller. Therefore, when the thermal head prints onto the card, the force of the thermal head pressing the card through the ink ribbon is stronger at the two end portions of the platen roller on which a reaction force acts, than at a platen roller having a constant diameter. In this way, the force of the thermal head pressing against the card through the ink ribbon tends to be uniform over the entire surface of the card. Therefore, at the outer peripheral edge in the width direction of the card, it is possible to suppress rubbing of the printing on the outer peripheral edge.

According to at least an embodiment of the present invention, the platen roller may comprise first cylindrical portions positioned at the two end portions and a second cylindrical portion positioned at the central portion and having an outer diameter smaller than the outer diameter of the first cylindrical portions.

According to at least an embodiment of the present invention, an outer diameter of the platen roller gradually may decrease from the two end portions toward the central portion.

According to at least an embodiment of the present invention, it is preferred that the card issuing device further include a first guide roller that is disposed downstream of the thermal head in a conveyance direction of the ink ribbon and that supports the ink ribbon by rotating along with the conveyance of the ink ribbon, and that an outer diameter of the two end portions of the first guide roller be smaller than the outer diameter of the central portion of the first guide roller. In this way, the first guide roller generates a tensile force in the central portion of the ink ribbon, so that the ink ribbon is less likely to be wrinkled. As a result, the thermal head can stably print onto the card.

According to at least an embodiment of the present invention, it is preferred that the card issuing device further include a second guide roller that is disposed upstream of the thermal head in a conveyance direction of the ink ribbon and that supports the ink ribbon by rotating along with the conveyance of the ink ribbon, and that an outer diameter of the two end portions of the second guide roller be smaller than an outer diameter of the central portion of the second guide roller. In this way, the second guide roller generates a tensile force in the central portion of the ink ribbon, so that the ink ribbon is less likely to be wrinkled. As a result, the thermal head can stably print onto the card.

According to at least an embodiment of the present invention, it is preferred that an outer peripheral surface of the first guide roller is an arcuate surface curved in a direction along a rotation axis of the first guide roller. In this way, wrinkles are less likely to occur in the ink ribbon, and thus the thermal head can perform more stable printing onto the card.

According to at least an embodiment of the present invention, it is preferred that an outer peripheral surface of the second guide roller is an arcuate surface curved in a direction along a rotation axis of the second guide roller. In this way, wrinkles are less likely to occur in the ink ribbon, and thus the thermal head can perform more stable printing onto the card.

According to at least an embodiment of the present invention, since the outer diameter at the two end portions of the platen roller is larger than the outer diameter at the central portion of the platen roller, the force of the thermal head pressing against the card through the ink ribbon when printing the card is stronger at the two end portions of the platen roller. In this way, the force of the thermal head pressing against the card through the ink ribbon tends to be uniform over the entire surface of the card. Therefore, at the outer peripheral edge in the width direction of the card, it is possible to suppress rubbing of the printing on the outer peripheral edge.

### BRIEF DESCRIPTION OF THE DRAWINGS

Embodiments will now be described, by way of example only, with reference to the accompanying drawings which are meant to be exemplary, not limiting, and wherein like elements are numbered alike in several figures, in which:

FIG. 1 is a cross-sectional perspective view of a card issuing device of a first embodiment;

FIG. 2 illustrates the relationship between guide rollers and an ink ribbon;

FIG. 3 illustrates the relationship between a printing portion and a platen roller when a thermal head is at a retracted position;

FIG. 4 illustrates the relationship between the printing portion and the platen roller when the thermal head is at a printing position;

FIG. 5 is a perspective view of the platen roller;

FIG. 6 is a plan view of a platen roller of a first modification; and

FIG. 7 is a plan view of a platen roller of a second modification.

### DETAILED DESCRIPTION

A card issuing device according to at least an embodiment of the present invention will now be described with reference to the accompanying drawings. In the following description, the three directions perpendicular to each other are referred to as the X-direction, Y-direction, and Z-direction. One side of the X-direction is an X1-direction and the other side is an X2-direction. One side of the Y-direction is a Y1-direction and the other side is a Y2-direction. One side of the Z-direction is a Z1-direction and the other side is a Z2-direction. The X-direction is the front-rear direction of the card issuing device. The X1-direction is forward, and the X2-direction is rearward. The Y-direction is the width direction of the card issuing device. The Y1-direction is one side in the width direction. The Y2-direction is the other side in the width direction. The Z-direction is the up-down direction of the card issuing device. The Z1-direction is downward, and the Z2-direction is upward.

### First Embodiment

### Overall Configuration

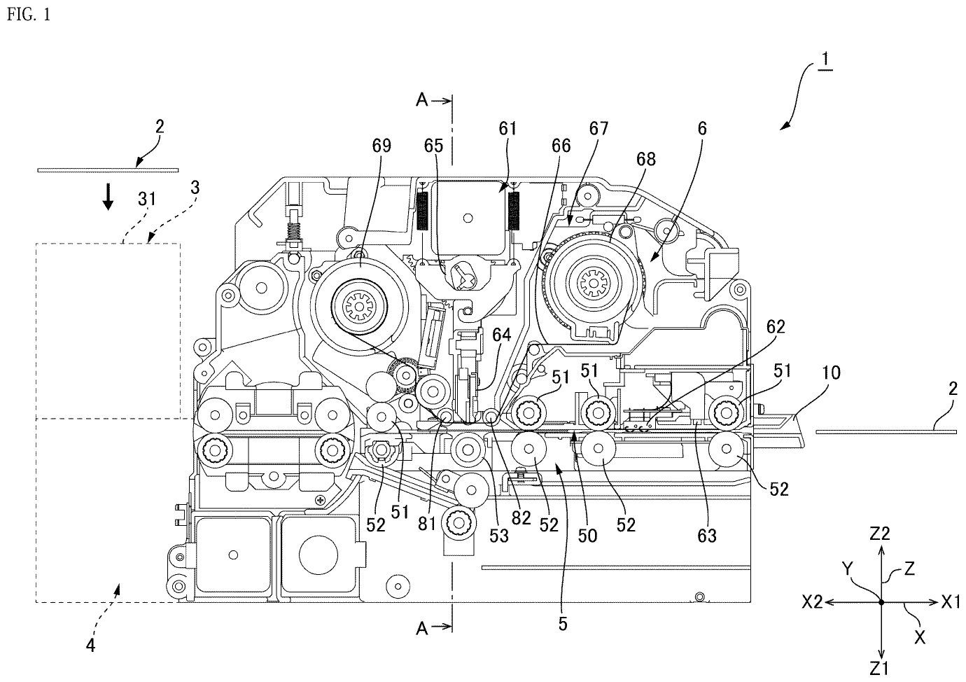

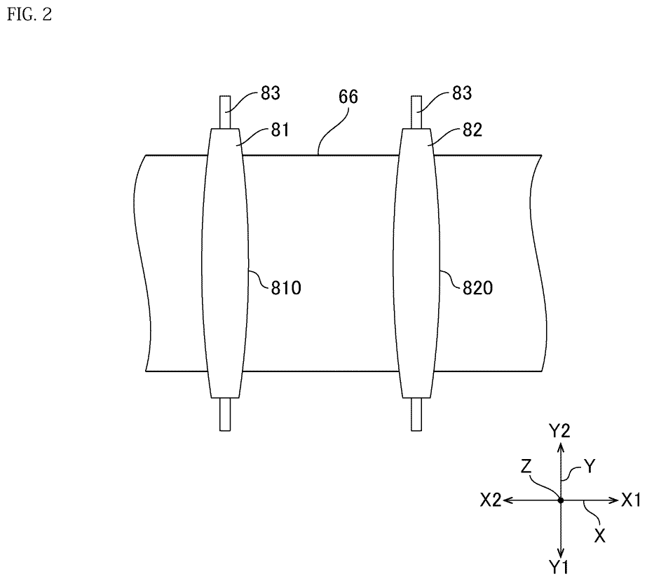

FIG. 1 is a cross-sectional perspective view of a card issuing device 1 of the first embodiment. FIG. 2 illustrates the relationship between guide rollers and an ink ribbon. The card issuing device 1 illustrated in FIG. 1 is used in a state being connected to a higher-order device (not illustrated). The card issuing device 1 issues a new card 2 as a medium on the basis of a card issuing command from a higher-order device. The card 2 has a card size defined by a predetermined ISO standard (for example, ID-1 of ISO/IEC7810) and has a substantially rectangular shape defined as 0.76-mm thick. The card 2 is composed of plastic. More specifically, the card 2 is a PVC card or a PET-G card. The card 2 includes a magnetic strip on which magnetic data is recorded, a printing part onto which thermal printing is performed, and an IC chip in which electronic data are stored.

As illustrated in FIG. 1, the card issuing device 1 includes a card accommodating portion 3 that accommodates multiple cards 2 before being issued, a card feeding mechanism 4 that feeds the cards 2 from the card accommodating portion 3, a card conveying mechanism 5 that conveys the cards 2 fed from the card feeding mechanism 4 toward a card discharge port 10, and a processing portion 6 that processes the cards 2.

### Card Accommodating Portion

As illustrated in FIG. 1, the card accommodating portion 3 includes a card stack portion 31. The card stack portion 31 has a cuboidal shape and extends in the Z-direction. Multiple cards 2 are accommodated in the card stack portion 31. The cards 2 are is inserted from the Z2-direction into the card stack portion 31 for accommodation.

### Card Feeding Mechanism

The card feeding mechanism 4 is disposed on the Z1-direction side of the card accommodating portion 3. The card feeding mechanism 4 includes a feeding claw that engages with the lowermost card 2 in the card stack portion 31 and sends out this card 2 to the outside of the card stack portion 31, and a claw feeding mechanism that moves the feeding claw. The card feeding mechanism 4 sends out the cards 2 accommodated in the card stack portion 31 toward the X1-direction.

### Card Conveying Mechanism

As illustrated in FIG. 1, the card conveying mechanism 5 conveys the cards 2 along a card conveying path 50 connected to the card discharge port 10. The card discharge port 10 is disposed on the X1-direction side of the card conveying mechanism 5. The card conveying path 50 extends in the X-direction from the X1-direction side of the card feeding mechanism 4 to the card discharge port 10.

The card conveying mechanism 5 includes a plurality of drive rollers 51 arranged along the card conveying path 50, a plurality of driven rollers 52 arranged along the card conveying path 50, and a circular platen roller 53. The drive rollers 51 are positioned on the Z2-direction side of the card conveying path 50. The driven rollers 52 are positioned on the Z1-direction side of the card conveying path 50 and faces the drive rollers 51.

The platen roller 53 is positioned on the Z1-direction side of the card conveying path 50. The platen roller 53 is disposed directly below a thermal head 64. Peripheral portions of the platen roller 53 is composed of rubber or the like. A motor, or a drive source, of the card conveying mechanism 5 is connected to the drive rollers 51 and the platen roller 53 via a power transmission mechanism. As the drive rollers 51 and the platen roller 53 rotate, the card 2 moves along the card conveying path 50.

### Processing Portion

As illustrated in FIG. 1, the processing portion 6 includes a printing portion 61 that performs printing onto the surface of a card 2, an IC contact 62 that comes into contact with an IC chip of the card 2, and a magnetic head 63 that performs at least one of reading of magnetic data recorded on the card 2 and recording of magnetic data on the card 2. The IC contact 62 and the magnetic head 63 are arranged along the card conveying path 50.

The printing portion 61 includes the thermal head 64 that thermally prints onto the card 2, a head moving mechanism 65, and an ink ribbon cartridge 67 including an ink ribbon 66. The thermal head 64 is disposed opposite to the platen roller 53 in the Z2-direction. The head moving mechanism 65 includes a motor and a transmission mechanism that transmits the driving force of the motor to the thermal head 64. The head moving mechanism 65 moves the thermal head 64 between a printing position at which the thermal head 64 is in contact with the upper surface of the card 2 through the ink ribbon 66 and a retracted position at which the thermal head 64 is retracted upward in the Z2-direction from the upper surface of the card conveying path 50.

The ink ribbon cartridge 67 is detachable from the body frame of the card issuing device 1. The ink ribbon cartridge 67 includes the ink ribbon 66, a supply roll 68 around which the ink ribbon 66 before the ink is transferred to the card 2 is wound, and a take-up roll 69 around which the ink ribbon 66 after the ink is transferred to the card 2 is wound. The supply roll 68 is positioned on the X1-direction side of the thermal head 64. The take-up roll 69 is positioned on the X2-direction side of the thermal head 64. That is, the X2-direction is the conveying direction of the ink ribbon 66, and the ink ribbon 66 moves in the X2-direction.

Here, the printing portion 61 includes a first guide roller 81 disposed on the X2-direction side of the thermal head 64 and a second guide roller 82 disposed on the X1-direction side of the thermal head 64. The first guide roller 81 is rotatably supported by a shaft member 83. The first guide roller 81 supports the ink ribbon 66 by rotating in accordance with the conveyance of the ink ribbon 66. The first guide roller 81 is composed of resin or metal, and extends in the Y-direction. As illustrated in FIG. 2, the width of the first guide roller 81 in the Y-direction is larger than the width of the ink ribbon 66 in the Y-direction. In the first guide roller 81, the outer diameter at the two end portions is smaller than the outer diameter at the central portion. An outer peripheral surface 810 of the first guide roller 81 is an arcuate surface curved in the Y-direction along the rotation axis of the first guide roller 81.

The second guide roller 82 is rotatably supported by the shaft member 83. The second guide roller 82 supports the ink ribbon 66 by rotating in accordance with the conveyance of the ink ribbon 66. The second guide roller 82 is composed of resin or metal, and extends in the Y-direction. As illustrated in FIG. 2, the width of the second guide roller 82 in the Y-direction is larger than the width of the ink ribbon 66 in the Y-direction. In the second guide roller 82, the outer diameter at the two end portions is smaller than the outer diameter at the central portion. An outer peripheral surface 820 of the second guide roller 82 is an arcuate surface curved in the Y-direction along the rotation axis of the second guide roller 82. In the present embodiment, the second guide roller 82 has the same shape as the first guide roller 81.

### Relationship Between Printing Portion and Platen Roller

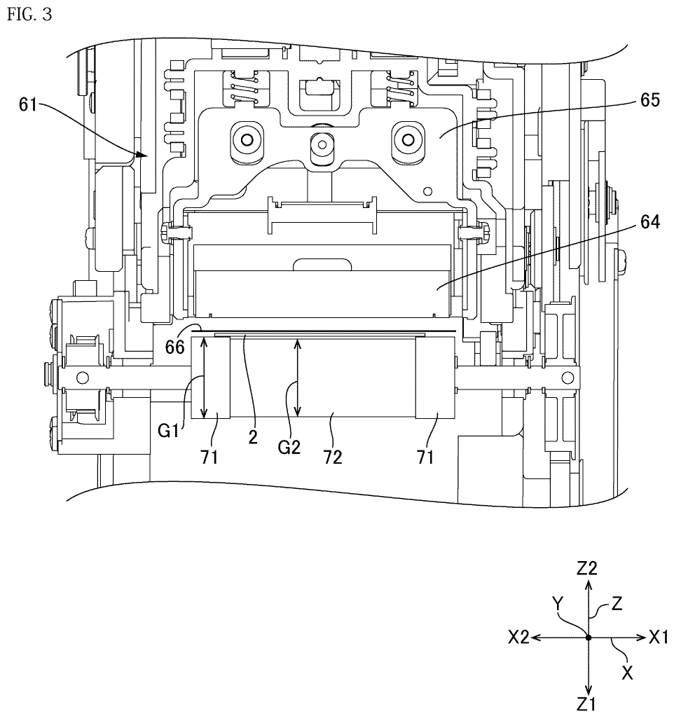

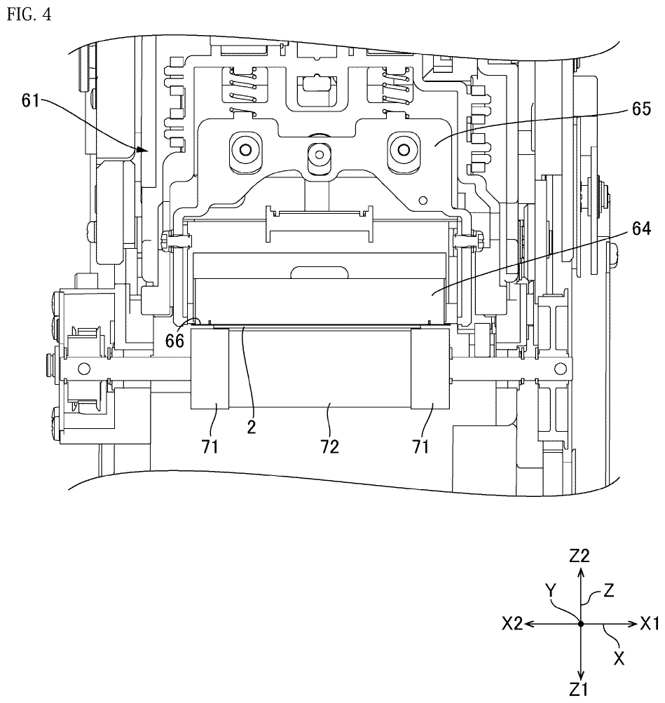

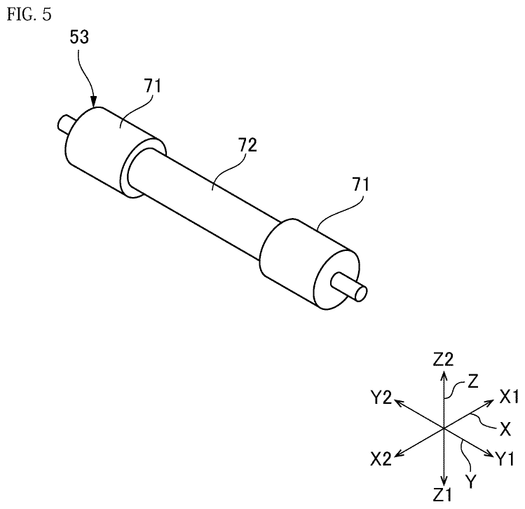

FIG. 3 illustrates the relationship between the printing portion 61 and the platen roller 53 when the thermal head 64 is at the retracted position. FIG. 4 illustrates the relationship between the printing portion 61 and the platen roller 53 when the thermal head 64 is at the printing position. FIG. 5 is a perspective view of the platen roller 53. As illustrated in FIGS. 3 and 4, the width of the ink ribbon 66 in the Y-direction is larger than the width of the card 2 in the Y-direction and the width of the thermal head 64 in the Y-direction. The width of the platen roller 53 in the Y-direction is larger than the width of a card 2 in the Y-direction. Here, as illustrated in FIGS. 3 to 5, the platen roller 53 includes first cylindrical portions 71 positioned at both end portions and a second cylindrical portion 72 positioned at a central portion. The first cylindrical portions 71 and the second cylindrical portion 72 have coaxial circular shapes. The second cylindrical portion 72 has a smaller outer diameter than the first cylindrical portions 71. That is, the outer diameter of the platen roller 53 at the two end portions is larger than the outer diameter at the central portion. When the platen roller 53 conveys a card 2, the first cylindrical portions 71 comes into contact with the outer peripheral edges of the card 2, which are two end portions of the card 2 in the Y-direction. In this embodiment, as illustrated in FIGS. 3 and 4, the first cylindrical portions 71 is in contact with the card 2 at areas between the outer peripheral edge and approximately 5 mm from the outer peripheral edge of the card 2 in the Y-direction.

In the present embodiment, as illustrated in FIG. 3, when the outer diameter of the first cylindrical portions 71 is G1 and the outer diameter of the second cylindrical portion 72 is G2, the following conditional expression is satisfied.

$$0.1 mm < G 1 - G 2 < 1. mm$$

Preferably, the following conditional expression is satisfied.

$$0.1 mm < G 1 - G 2 < 0.5 mm$$

More preferably, the following conditional expression is satisfied.

$$0.1 mm < G 1 - G 2 < 0.2 mm$$

A printing operation of the card issuing device 1 will now be described. When the card conveying mechanism 5 conveys a card 2 from the card feeding mechanism 4 in the X1-direction, as illustrated in FIG. 3, the thermal head 64 is positioned at the retracted position. In this case, the ink ribbon 66 is separated from the card 2 in the Z1-direction.

Next, the card conveying mechanism 5 conveys the card 2 in the X1-direction from the thermal head 64.

The card conveying mechanism 5 stops the conveyance of the card 2 after conveying the card 2 in the X1-direction from the thermal head 64. Then, the head moving mechanism 65 moves the thermal head 64 to the printing position, as illustrated in FIG. 4. Next, the card conveying mechanism 5 conveys the card 2 in the X2-direction from the thermal head 64. At this time, the thermal head 64 brings the ink ribbon 66 into contact with the upper surface of the card 2 and prints onto the upper surface of the card 2. Here, the force of the head moving mechanism 65 pressing the thermal head 64 against the card 2 is stronger at both end portions of the card 2 in contact with the first cylindrical portions 71 in the Y-direction. When the head moving mechanism 65 presses the thermal head 64 against the card 2, the central portion of the card 2 may slightly bend in the Z2-direction. When the central portion of the card 2 bends, the central portion of the card 2 may come into contact with the second cylindrical portion 72.

### Operation Effect

According to the present embodiment, the platen roller 53 includes the first cylindrical portions 71 positioned at both end portions and having the outer diameter at both end portions larger than the outer diameter at the central portion, and the second cylindrical portion 72 positioned at the central portion and having an outer diameter smaller than that of the first cylindrical portions 71. Therefore, when the thermal head 64 prints onto the card 2, the force of the thermal head 64 pressing the card 2 through the ink ribbon 66 is stronger at the first cylindrical portions 71, which are the two end portions of the platen roller 53 on which a reaction force acts, than at platen rollers having a constant diameter. As a result, the force of the thermal head 64 pressing the card 2 through the ink ribbon 66 is uniform over the entire surface of the card 2. Therefore, at the outer peripheral edge of the card 2 in the Y-direction, it is possible to suppress rubbing of the printing on the outer peripheral edge.

In this embodiment, the card 2 is a PVC card or a PET-G card having a width of 0.76 mm in accordance with a predetermined ISO standard. When the outer diameter of the first cylindrical portions 71 is G1 and the outer diameter of the second cylindrical portion 72 is G2, the following conditional expression is satisfied.

0.1 mm<G1-G2<1.0 mm

In this way, it is possible to prevent the printing on the outer peripheral edge from being rubbed at the outer peripheral edge of the card 2 in the Y-direction. If the lower limit of the conditional expression is not reached, the difference between the outer diameter G1 of the first cylindrical portions 71 and the outer diameter of the second cylindrical portion 72 is too small. Therefore, the force of the thermal head 64 pressing against the card 2 through the ink ribbon 66 is less likely to be intense at the two end portions of the platen roller 53. In this way, it is not possible to prevent the printing on the outer peripheral edge from being rubbed at the outer peripheral edge of the card 2 in the Y-direction. If G1-G2 exceeds an upper limit, the card 2 is curves significantly when the central portion of the card 2 bends and comes into contact with the second cylindrical portion 72 due to the force of the thermal head 64 pressing the card 2 through the ink ribbon 66. This significant curving of the card 2 causes unstable printing on the card 2 by the thermal head 64, causing a risk of rubbing of the printing in a portion of the card 2.

The card issuing device 1 of the present embodiment includes the first guide roller 81 that is disposed downstream of the thermal head 64 in the conveyance direction of the ink ribbon 66 and that supports the ink ribbon by rotating in accordance with the conveyance of the ink ribbon. In the first guide roller 81, the outer diameter at the two end portions is smaller than the outer diameter at the central portion. In this way, the first guide roller 81 generates a tensile force in the central portion of the ink ribbon 66, so that the ink ribbon 66 is less likely to be wrinkled. As a result, the thermal head 64 can stably print onto the card 2.

The card issuing device 1 of the present embodiment includes the second guide roller 82 that is disposed upstream of the thermal head 64 in the conveyance direction of the ink ribbon 66 and that supports the ink ribbon 66 by rotating in accordance with the conveyance of the ink ribbon 66. In the second guide roller 82, the outer diameter at the two end portions is smaller than the outer diameter at the central portion. In this way, the second guide roller 82 generates a tensile force in the central portion of the ink ribbon 66, so that the ink ribbon 66 is less likely to be wrinkled. As a result, the thermal head 64 can stably print onto the card 2.

In the present embodiment, the outer peripheral surface 810 of the first guide roller 81 is an arcuate surface curved in the Y-direction along the rotation axis of the first guide roller 81. An outer peripheral surface 820 of the second guide roller 82 is an arcuate surface curved in the Y-direction along the rotation axis of the second guide roller 82. In this way, wrinkles are less likely to occur in the ink ribbon 66, and thus the thermal head 64 can perform more stable printing onto the card 2.

### Modifications

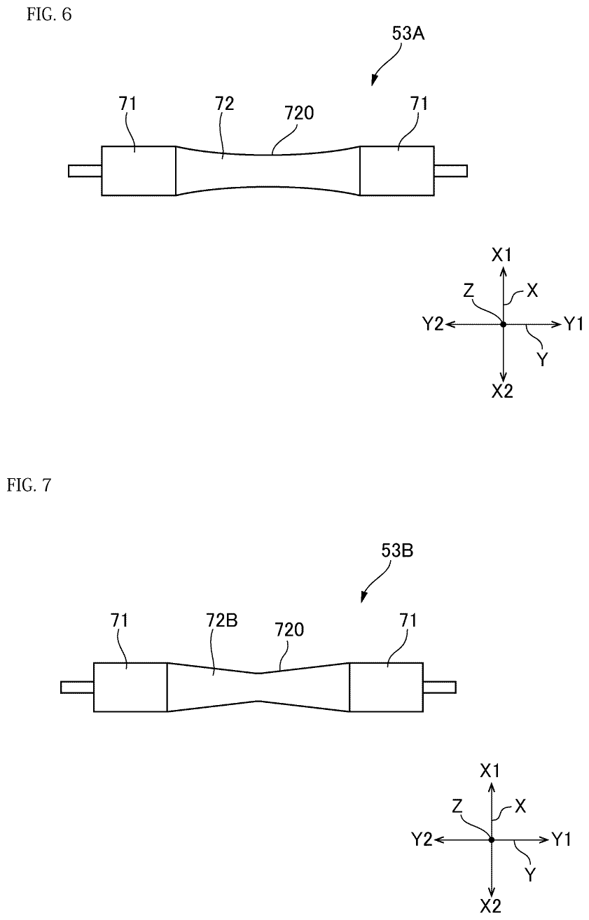

FIG. 6 is a plan view of a platen roller of a first modification. FIG. 7 is a plan view of a platen roller of a second modification. The platen rollers 53 of the modifications may have an outer diameter that gradually decreases from the two ends toward the central portion. Here, as illustrated in FIG. 6, a platen roller 53A of the first modification includes first cylindrical portions 71 positioned at both end portions and a second cylindrical portion 72A positioned at a central portion. An outer peripheral surface 720 of the second cylindrical portion 72A is an arcuate surface curved in a concave shape toward the central portion. As illustrated in FIG. 7, a platen roller 53B of the second modification includes first cylindrical portions 71 positioned at both end portions and a second cylindrical portion 72B positioned at a central portion. The outer peripheral surface 720 of the second cylindrical portion 72B is a tapered surface tilting radially inward toward the central portion. The platen rollers of the first and second modifications can obtain the same effect as that of the platen roller 53 of the above-described embodiment.

The platen roller of the above-described modification includes the first cylindrical portions 71 having a constant diameter at both end portions, but the first cylindrical portions 71 may not be provided. More specifically, the platen roller may have an outer diameter gradually decreases from the two end portions toward the central portion without including the portions having a constant diameter. In this case, the outer peripheral surface of the platen roller is only an arcuate surface curved in a concave shape toward the central portion. Alternatively, the outer peripheral surface of the platen roller is only a tapered surface tilting toward the central portion, or the inner diameter side.

The card 2 used in the card issuing device 1 is not limited to a 0.76-mm thick card in accordance with a predetermined ISO standard. The card issuing device 1 can printing onto cards of various card sizes or thicknesses.

The present technique can be configured as follows.

(1)

A card issuing device including:
a thermal head that prints onto a medium by heating;
a circular platen roller that is disposed opposite to the thermal head and conveys the medium by rotating while the medium is held between the platen roller and the thermal head; and
an ink ribbon that is conveyed between the thermal head and the platen roller while the ink ribbon is superposed with the medium,
wherein an outer diameter at two end portions of the platen roller is larger than an outer diameter at a central portion of the platen roller.
   (2)

The card issuing device according to (1), wherein the platen roller comprises first cylindrical portions positioned at the two end portions and a second cylindrical portion that is positioned at the central portion and having an outer diameter smaller than the outer diameter of the first cylindrical portions.

(3)

The card issuing device according to (1), wherein an outer diameter of the platen roller gradually decreases from the two end portions toward the central portion.

(4)

The card issuing device according to any one of (1) to (3), further including:
a first guide roller that is disposed downstream of the thermal head in a conveyance direction of the ink ribbon and that supports the ink ribbon by rotating along with the conveyance of the ink ribbon,
wherein an outer diameter of the two end portions of the first guide roller is smaller than the outer diameter of the central portion of the first guide roller.
   (5)

The card issuing device according to any one of (1) to (4), further including:
a second guide roller that is disposed upstream of the thermal head in the conveyance direction of the ink ribbon and that supports the ink ribbon by rotating along with the conveyance of the ink ribbon,
wherein an outer diameter of the two end portions of the second guide roller is smaller than an outer diameter of the central portion of the second guide roller.
   (6)

The card issuing device according to (4), wherein an outer peripheral surface of the first guide roller is an arcuate surface curved in a direction along a rotation axis of the first guide roller.

(7)

The card issuing device according to (5), an outer peripheral surface of the second guide roller is an arcuate surface curved in a direction along a rotation axis of the second guide roller.

What is claimed is:

1. A card issuing device comprising:
a thermal head that prints onto a medium by heating;
a circular platen roller that is disposed opposite to the thermal head and conveys the medium by rotating while the medium is held between the platen roller and the thermal head; and
an ink ribbon that is conveyed between the thermal head and the platen roller while the ink ribbon is superposed with the medium,
wherein an outer diameter at two end portions of the platen roller is larger than an outer diameter at a central portion of the platen roller.

2. The card issuing device according to claim 1, wherein the platen roller comprises first cylindrical portions positioned at the two end portions and a second cylindrical portion that is positioned at the central portion and having an outer diameter smaller than the outer diameter of the first cylindrical portions.

3. The card issuing device according to claim 1, wherein an outer diameter of the platen roller gradually decreases from the two end portions toward the central portion.

4. The card issuing device according to claim 1, further comprising:
a first guide roller that is disposed downstream of the thermal head in a conveyance direction of the ink ribbon and that supports the ink ribbon by rotating along with the conveyance of the ink ribbon,
wherein an outer diameter of the two end portions of the first guide roller is smaller than the outer diameter of the central portion of the first guide roller.

5. The card issuing device according to claim 1, further comprising:
a second guide roller that is disposed upstream of the thermal head in a conveyance direction of the ink ribbon and that supports the ink ribbon by rotating along with the conveyance of the ink ribbon,
wherein an outer diameter of the two end portions of the second guide roller is smaller than an outer diameter of the central portion of the second guide roller.

6. The card issuing device according to claim 4, wherein an outer peripheral surface of the first guide roller is an arcuate surface curved in a direction along a rotation axis of the first guide roller.

7. The card issuing device according to claim 5, wherein an outer peripheral surface of the second guide roller is an arcuate surface curved in a direction along a rotation axis of the second guide roller.

8. The card issuing device according to claim 2, further comprising:
a first guide roller that is disposed downstream of the thermal head in a conveyance direction of the ink ribbon and that supports the ink ribbon by rotating along with the conveyance of the ink ribbon,
wherein an outer diameter of the two end portions of the first guide roller is smaller than an outer diameter of the central portion of the first guide roller.

9. The card issuing device according to claim 8, further comprising:
a second guide roller that is disposed upstream of the thermal head in a conveyance direction of the ink ribbon and that supports the ink ribbon by rotating along with the conveyance of the ink ribbon,
wherein an outer diameter of the two end portions of the second guide roller is smaller than an outer diameter of the central portion of the second guide roller.

10. The card issuing device according to claim 8, wherein an outer peripheral surface of the first guide roller is an arcuate surface curved in a direction along a rotation axis of the first guide roller.

11. The card issuing device according to claim 9, wherein an outer peripheral surface of the second guide roller is an arcuate surface curved in a direction along a rotation axis of the second guide roller.

12. The card issuing device according to claim 3, further comprising:
a first guide roller that is disposed downstream of the thermal head in a conveyance direction of the ink ribbon and that supports the ink ribbon by rotating along with the conveyance of the ink ribbon,
wherein an outer diameter of the two end portions of the first guide roller is smaller than an outer diameter of the central portion of the first guide roller.

13. The card issuing device according to claim 12, further comprising:
a second guide roller that is disposed upstream of the thermal head in a conveyance direction of the ink ribbon and that supports the ink ribbon by rotating along with the conveyance of the ink ribbon,
wherein an outer diameter of the two end portions of the second guide roller is smaller than an outer diameter of the central portion of the second guide roller.

14. The card issuing device according to claim 12, wherein an outer peripheral surface of the first guide roller is an arcuate surface curved in a direction along a rotation axis of the first guide roller.

15. The card issuing device according to claim 13, wherein an outer peripheral surface of the second guide roller is an arcuate surface curved in a direction along a rotation axis of the second guide roller.

16. The card issuing device according to claim 4, further comprising:
a second guide roller that is disposed upstream of the thermal head in a conveyance direction of the ink ribbon and that supports the ink ribbon by rotating along with the conveyance of the ink ribbon,
wherein an outer diameter of the two end portions of the second guide roller is smaller than an outer diameter of the central portion of the second guide roller.

17. The card issuing device according to claim 16, wherein an outer peripheral surface of the second guide roller is an arcuate surface curved in a direction along a rotation axis of the second guide roller.
